(19) United States
(12) Patent Application Publication
(10) Pub. No.: US 2016/0344454 A1
(43) Pub. Date: Nov. 24, 2016

(54) METHOD AND APPARATUS FOR CONTROLLING ANTENNA IN COMMUNICATION SYSTEM

(71) Applicant: Samsung Electronics Co., Ltd., Gyeonggi-do (KR)

(72) Inventor: Jong-Dae BAE, Gyeonggi-do (KR)

(73) Assignee: Samsung Electronics Co., Ltd.

(21) Appl. No.: 15/063,018

(22) Filed: Mar. 7, 2016

(30) Foreign Application Priority Data
May 18, 2015 (KR) 10-2015-0068966

(51) Int. Cl. H04B 7/04; H04W 88/02

(52) U.S. Cl. CPC H04B 7/0413; H04W 88/02

(57) ABSTRACT

A User Equipment (UE) apparatus in a communication system is provided. The UE apparatus includes a first cellular antenna, a second cellular antenna mounted on the UE apparatus at a location spaced apart from the first cellular antenna, a connectivity antenna mounted on the UE apparatus at a location adjacent to the second cellular antenna, a first cellular communication unit connected to the first cellular antenna, and an integrated circuit including a second cellular communication unit connected to the second cellular antenna and a connectivity communication unit connected to the connectivity antenna.

### PRIORITY

This application claims priority under 35 U.S.C. §119(a) to Korean Patent Application Serial No. 10-2015-0068966, which was filed in the Korean Intellectual Property Office on May 18, 2015, the entire contents of which are incorporated herein by reference.

### BACKGROUND

1. Field of the Disclosure

The present disclosure relates generally to a method and apparatus for controlling an antenna in a communication system, and more particularly, to an apparatus and method for arranging and connecting communication units in a User Equipment (UE).

2. Description of the Related Art

A cellular transmission/reception apparatus uses a diversity function in order to ensure reception performance and supports a multi-band and a multi-mode, so as to require two or more isolated antennas. A connectivity transmission/reception apparatus requires a cellular antenna and one or more separate isolated antennas in order to minimize interference with the cellular antenna. With improvement of functions of a UE, the number of antennas tends to be consistently increased.

Meanwhile, since the UE is required to be highly integrated in order to achieve miniaturization, a semiconductor device can be used for the isolated antenna. In order to miniaturize the UE, functions for main transmission/reception signal processing and diversity transmission/reception signal processing of the cellular antenna, and Global Navigation Satellite System (GNSS) reception signal processing and Wireless-Fidelity (Wi-Fi®)/Bluetooth®/Advanced Network Tools Plus (ANT+) transmission/reception signal processing of a connectivity antenna can be also integrated into the semiconductor device.

In a UE, a plurality of antennas can be arranged in an isolated state in order to optimize a transmission/reception performance. However, when an antenna and a communication unit operably connected thereto are arranged in the UE, a distance between the communication unit of a highly-integrated semiconductor device and the antenna may become longer. Accordingly, communication performance of the UE may be reduced and/or power consumption of the UE may be increased.

### SUMMARY

According to an aspect of the present disclosure, there is provided an apparatus and method for arranging and connecting communication units, which correspond to a plurality of antennas in a UE.

According to an aspect of the present disclosure, there is provided an apparatus and method in which a main cellular transceiver connected to a main cellular antenna can be integrated with a part or an entirety of a connectivity transceiver in the UE having a plurality of cellular antennas and cellular transceivers.

According to an aspect of the present disclosure, there is provided an apparatus and method in which a diversity cellular transceiver connected to a diversity cellular antenna can be integrated with a part or an entirety of a connectivity transceiver in a UE having a plurality of cellular antennas and cellular transceivers.

According to an aspect of the present disclosure, there is provided an apparatus and method in which a pair or a part of transmission and reception of Multi-Input Multi-Outputs (MIMOs) of connectivity transceivers that are connected to a corresponding connectivity antennas can be integrated with a part or an entirety of cellular transceivers in a UE having a plurality of cellular antennas and the plurality of cellular transceivers.

In accordance with an aspect of the present disclosure, there is provided a UE apparatus in a communication system. The UE apparatus includes a first cellular antenna, a second cellular antenna mounted on the UE apparatus at a location spaced apart from the first cellular antenna, a connectivity antenna mounted on the UE apparatus at a location adjacent to the second cellular antenna, a first cellular communication unit connected to the first cellular antenna, and an integrated circuit including a second cellular communication unit that is connected to the second cellular antenna and a connectivity communication unit that is connected to the connectivity antenna.

In accordance with an aspect of the present disclosure, there is provided a method of manufacturing an integrated circuit configured for use with a UE apparatus which includes a first cellular antenna, a second cellular antenna, a connectivity antenna, and a first cellular communication unit connected to the first cellular antenna. The method includes forming a second cellular communication unit on the integrated circuit, the second cellular communication unit connected to the second cellular antenna, which is mounted on the UE apparatus at a location spaced apart from the first cellular antenna and forming a connectivity communication unit on the integrated circuit, the connectivity communication unit connected to the connectivity antenna, which is mounted on the UE apparatus at a location adjacent to the second cellular antenna.

In accordance with an aspect of the present disclosure, there is provided a method of manufacturing a UE apparatus. The method includes mounting a first cellular antenna on the UE apparatus, mounting a second cellular antenna on the UE apparatus at a location spaced apart from the first cellular antenna, mounting a connectivity antenna on the UE apparatus at a location adjacent to the second cellular antenna, forming a first cellular communication unit on a first integrated circuit, the first cellular communication unit connected to the first cellular antenna, and forming a second cellular communication unit on a second integrated circuit, the second cellular communication unit connected to the second cellular antenna and a connectivity communication unit connected to the connectivity antenna.

In accordance with an aspect of the present disclosure, there is provided a chipset for use with a UE apparatus which includes a first cellular antenna, a second cellular antenna, a connectivity antenna, and a first cellular communication unit connected to the first cellular antenna. The chipset includes a second cellular communication unit connected to the second cellular antenna and a connectivity communication unit connected to the connectivity antenna.

In accordance with an aspect of the present disclosure, there is provided a UE apparatus in a communication system. The UE apparatus includes a first cellular antenna, a second cellular antenna, a connectivity antenna, a first cellular communication unit connected to the first cellular antenna, and an integrated circuit including at least partially thereon a second cellular communication unit connected to the second cellular antenna and a connectivity communication unit connected to the connectivity antenna.

According to an aspect of the present disclosure, in a UE, a cellular main antenna and a cellular diversity antenna are spaced apart from each other by a predetermined interval and a main or diversity cellular transceiver is integrated with a part or an entirety of a connectivity transceiver, so that efficiency of cellular communication can be improved. According to an aspect of the present disclosure, a distance of a Radio Frequency (RF) chip communicating with the cellular diversity antenna is relatively closer when compared to conventional RF chips and cellular diversity antennas, so that efficiency of a performance of a cellular diversity antenna can be improved.

Further, connectivity antennas are spaced apart from each other by a predetermined interval and a pair or a part of transmission and reception of MIMOs of connectivity transceivers that are connected to corresponding connectivity antennas is integrated with a part or an entirety of a cellular transceiver, so that efficiency of connectivity communication can be improved.

According to an aspect of the present disclosure, antennas of connectivity communication units performing MIMO communication are spaced apart from each other by a predetermined distance, and a distance between an RF chip and the corresponding connectivity communication units is relatively closer when compared to conventional RF chips and connectivity communication units , so that efficiency of a performance of a connectivity MIMO antenna can be improved.

### BRIEF DESCRIPTION OF THE DRAWINGS

The above and other aspects, features, and advantages of the present disclosure will be more apparent from the following detailed description taken in conjunction with the accompanying drawings, in which:

FIG. 1A is a diagram illustrating a configuration of a UE when a connectivity RF chip and a base band are configured as separate chips, respectively;

FIG. 1B is a diagram illustrating a configuration of a UE when a connectivity RF chip and a base band are configured as one chip;

FIGS. 2A-2D are diagrams illustrating arrangements of cellular and connectivity antennas of a UE in a communication system;

FIG. 3 is a diagram illustrating an antenna connection with an RF chip in a UE;

FIG. 4 is a diagram illustrating a front end of a cellular RF chip, according to an embodiment of the present disclosure;

FIG. 5 is a diagram illustrating a UE apparatus, according to an embodiment of the present disclosure;

FIG. 6 is a diagram illustrating a cellular diversity chip and a connectivity chip that are configured as one chip, according to an embodiment of the present disclosure;

FIG. 7 is a diagram illustrating a UE apparatus having a cellular main antenna and a cellular diversity antenna performing communication through different chips, according to an embodiment of the present disclosure;

FIG. 8 is a diagram illustrating a UE apparatus having a cellular main antenna and a cellular diversity antenna performing communication through a chip in which a connectivity RF chip and a connectivity Modulator-Demodulator (MODEM) are integrated, according to an embodiment of the present disclosure;

FIG. 9 is a diagram illustrating a cellular main RF chip and a diversity RF chip that are configured as one chip together with a connectivity RF chip, according to an embodiment of the present disclosure;

FIG. 10 is a diagram illustrating a UE apparatus having a cellular main antenna and a cellular diversity antenna performing communication through an RF chip in a MIMO scheme, according to an embodiment of the present disclosure; and

FIG. 11 is a diagram illustrating a UE apparatus having a cellular main antenna and a cellular diversity antenna performing communication through a chip, in which an RF chip and a MODEM are integrated, in an MIMO scheme, according to an embodiment of the present disclosure.

### DETAILED DESCRIPTION

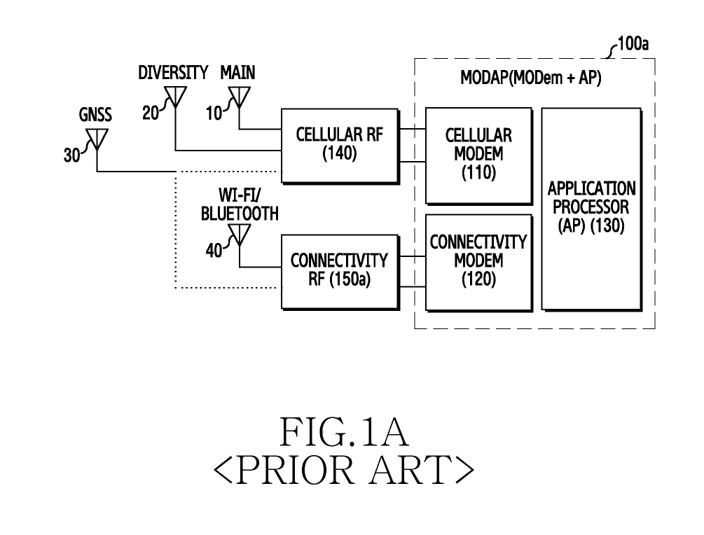

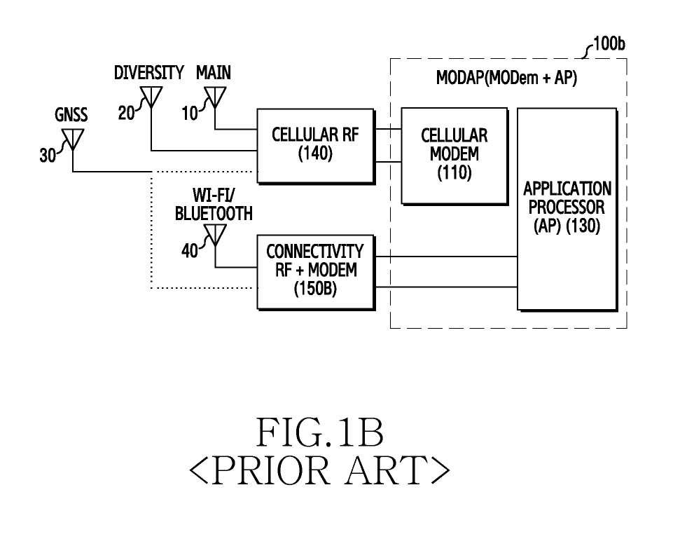

Hereinafter, a technology of controlling a communication antenna will be described. A UE according to the present disclosure includes a mobile UE such as a cellular phone and a smart phone. The UE can perform cellular communication and connectivity communication. Further, in the cellular communication, a main antenna and a diversity antenna are provided, thereby performing a diversity communication function. FIGS. 1A and 1B illustrate configurations of UEs which can perform diversity cellular communication.

FIG. 1A is a diagram illustrating a UE when a connectivity RF chip and a base band are configured as separate chips.

Referring to FIG. 1A, a MODEM integrated chip (MODEM+AP; MODAP) in which a MODEM and a processor are combined may include a cellular MODEM 110, a connectivity MODEM 120, and an Application Processor (AP) 130. The cellular MODEM 110 can be connected to a cellular RF chip 140, and the cellular RF chip 140 can be connected to a cellular main antenna 10 and a cellular diversity antenna 20. The connectivity MODEM 120 can be connected to a connectivity RF chip 150a, and the connectivity RF chip 150a can be connected to a Wi-Fi® or Bluetooth® antenna 40. Further, a GNSS antenna 30 can be connected to the cellular RF chip 140 or the connectivity RF chip 150a. The AP 130 can control the UE using information received from the cellular MODEM 110 and the connectivity MODEM 120. Further, the AP 130 can control to transmit information of the UE through the cellular MODEM 110 and the connectivity MODEM 120.

FIG. 1B is a diagram illustrating a UE when a connectivity RF chip and a base band are configured as one chip.

Referring to FIG. 1B, a MODEM integrated chip 100b in which a MODEM and a processor are combined may include the cellular MODEM 110 and the application processor 130. The cellular MODEM 110 can be connected to the cellular RF chip 140, and the cellular RF chip 140 can be connected to the cellular main antenna 10 and the cellular diversity antenna 20. The connectivity RF chip 150a in FIG. 1A is configured separately from the connectivity MODEM 120. However, in FIG. 1B, an integrated connectivity chip 150b is configured as one chip by combining the connectivity RF chip 150a and the connectivity MODEM 120. The integrated connectivity chip 150b can be connected to the Wi-Fi® or Bluetooth® antenna 40. Further, the GNSS antenna 30 can be connected to the cellular RF chip 140 or the connectivity chip 150b. The AP 130 can control the UE by receiving information from the cellular MODEM 110 and the integrated connectivity chip 150b. Further, the AP 130 can control to transmit information of the UE through the cellular MODEM 110 and the integrated connectivity MODEM 150b.

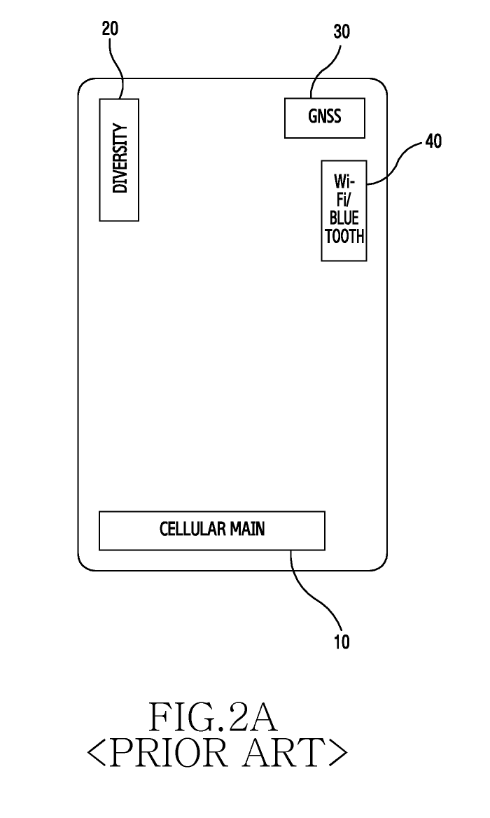

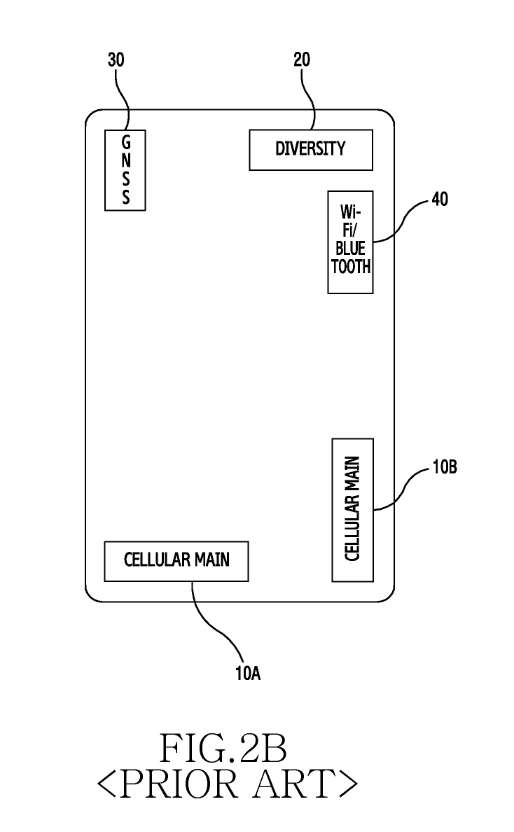

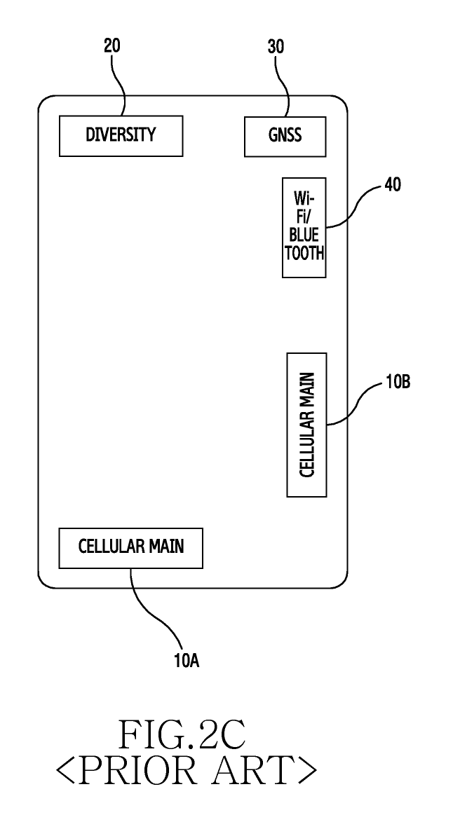

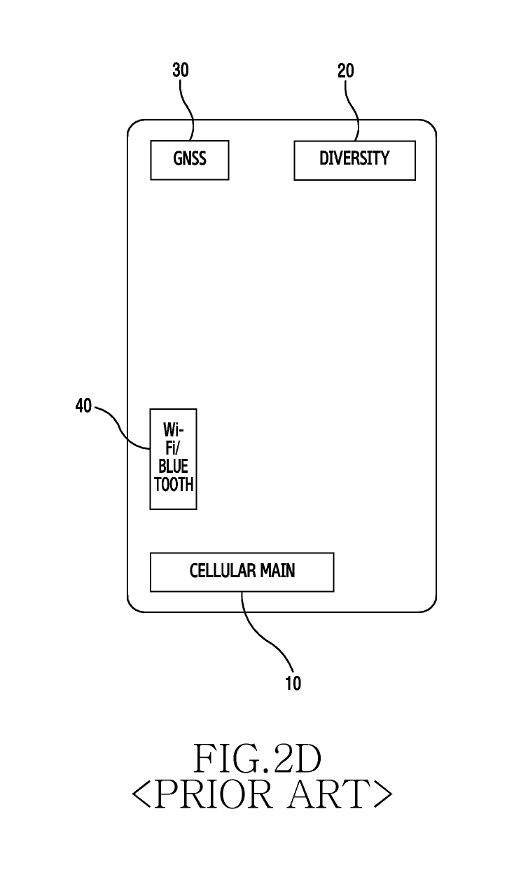

FIGS. 2A-2D are diagrams illustrating arrangements of cellular and connectivity antennas of a UE in a communication system.

More particularly, FIGS. 2A-2D illustrate examples of locations of cellular and connectivity antennas in a wireless UE. The cellular antenna and the connectivity antenna are transmission/reception standards for wireless communication, but have been individually developed by a specific manufacturer based on the manufacturer's preferences, guidelines, needs, etc. Accordingly, RF chips for a UE have been independently developed, and RF chips for the cellular antenna and the connectivity antenna have been developed in a separated form.

Referring to FIG. 2A, a UE may include a cellular main antenna 10, a cellular diversity antenna 20, a GNSS antenna 30, and a Wi-Fi®/Bluetooth® antenna 40.

In FIG. 2A, an interval, i.e., a distance, between the cellular main antenna 10 and the cellular diversity antenna 20 is relatively large. However, when the cellular RF chip 140 for communicating with the cellular main antenna 10 and the cellular diversity antenna 20 is installed adjacent to the cellular main antenna 10 in order to improve a performance of the cellular main antenna 10, a distance between the installed cellular RF chip 140 and the cellular diversity antenna 20 may cause deterioration of a performance.

FIG. 2B, which is similar to FIG. 2A, illustrates an interval between the cellular main antennas 10a and 10b and the cellular diversity antenna 20 which is also relatively large. However, when the cellular RF chip 140 for communicating with the cellular main antenna 10 and the cellular diversity antenna 20 is installed adjacent to the cellular main antenna 10, in order to improve a performance of the cellular main antenna 10, a distance between the installed cellular RF chip 140 and the cellular diversity antenna 20 may cause deterioration of a performance. Further, in this case, since the cellular main antenna 10b and a Wi-Fi®/Bluetooth® antenna 40 are arranged relatively close to each other, interference of the Wi-Fi®/Bluetooth® antenna 40 may cause deterioration of a performance of the cellular main antenna 1b.

FIG. 2C, which is similar to FIG. 2B, illustrates an interval between the cellular main antennas 10a and 10b and the cellular diversity antenna 20 which is also relatively large. However, when the cellular RF chip 140 for communicating with the cellular main antenna 10 and the cellular diversity antenna 20 is installed adjacent to the cellular main antenna 10, in order to improve a performance of the cellular main antenna 10, a distance between the installed cellular RF chip 140 and the cellular diversity antenna 20 may cause deterioration of a performance. Further, in this case, since the cellular main antenna 10b and a Wi-Fi®/Bluetooth® antenna 40 are arranged relatively close to each other, interference of the Wi-Fi®/Bluetooth® antenna 40 may cause deterioration of a performance of the cellular main antenna lb.

In FIG. 2D, an interval between the cellular main antenna 10 and the cellular diversity antenna 20 is relatively larger. However, since the cellular main antenna 10 and the Wi-Fi®/Bluetooth® antenna 40 are arranged relatively close to each other, interference of the Wi-Fi®/Bluetooth® antenna 40 may cause deterioration of a performance of the cellular main antenna 10.

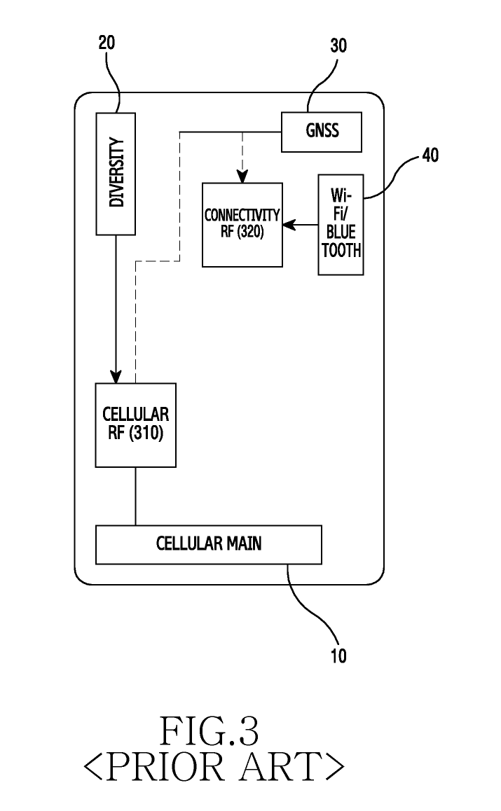

FIG. 3 is a diagram illustrating an antenna connection with an RF chip in a UE.

Referring to FIG. 3, a cellular RF chip 310 and a connectivity RF chip 320 are provided in the UE, the cellular RF chip 310 may be connected to the cellular main antenna 10 and the cellular diversity antenna 20, and the connectivity RF chip 320 may be connected to the Wi-Fi®/Bluetooth® antenna 40 and the GNSS antenna 30. Here, the GNSS antenna 30 may be connected to the cellular RF chip 310.

The cellular RF chip 310 is arranged relatively close to the cellular main antenna 10, in order to improve a performance of a main signal. However, as a result thereof, a performance of a signal received through the cellular diversity antenna 20, which is relatively far from the cellular RF chip, may deteriorate. Meanwhile, it is typical for the Wi-Fi®/Bluetooth® antenna 40 and the GNSS antenna 30 to be located as far from the cellular main antenna 10 as possible, and for the connectivity RF chip 320 to be located relatively close to the Wi-Fi®/Bluetooth® antenna 40 and the GNSS antenna 30. For this reason, although the cellular RF chip 310 and the connectivity RF chip 320 are integrated into one chip, so as to reduce an area inside the UE and reduce costs consumed for chip manufacturing by manufacturing each of the chips as one chip, such a configuration is, typically, undesired, due to concern regarding deterioration of performance.

In accordance with the present disclosure, the configurations of the cellular main antennas and the cellular diversity antennas described hereinafter overcome the shortcomings associated with the arrangements illustrated in FIG. 2A to FIG. 3. More particularly, in accordance with the present disclosure, an interval between a cellular main antenna and a cellular diversity antenna can relatively large, an RF chip communicating with the cellular main antenna and an RF chip communicating with the cellular diversity antenna can be separately installed, and the cellular RF chip and the connectivity RF chip can be integrated into one chip.

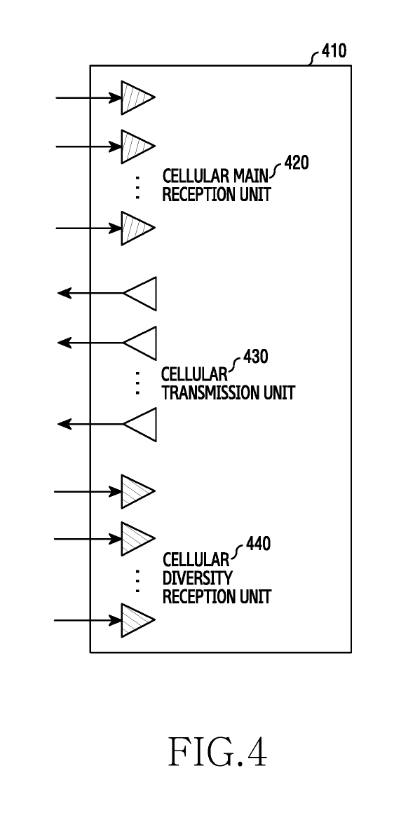

FIG. 4 is a diagram illustrating a front end of a cellular RF chip 410, according to an embodiment of the present disclosure.

Referring to FIG. 4, the cellular RF chip 410 may include a cellular main reception unit 420, a cellular transmission unit 430, and a cellular diversity reception unit 440. The RF chip 410 can be used with any of the aforementioned devices described above with reference with FIG. 1A to FIG. 3.

The cellular main communication unit 420 and the cellular diversity communication unit 440 receive the same signal. The cellular main communication unit 420 receives a signal for performing cellular communication. The cellular diversity communication unit 440 is an auxiliary communication unit for coping with reception performance reduction resulting from fading. The cellular transmission unit 430 transmits information included in a UE to one or more other communication devices.

The cellular diversity communication unit 440 performs communication through a diversity scheme. The cellular main antenna 10, of FIG. 1A, can be connected to the cellular main communication unit 420 and the cellular diversity antenna 20, of FIG. 1A, can be connected to the cellular diversity communication unit 440, and each of the cellular main antenna 10 and cellular diversity antenna 20 can be mounted relatively far apart from each other in order to maximize an effect of the diversity communication. When using the RF chip 410 of FIG. 4, the cellular main antenna 10 and the cellular diversity antenna 20 can be mounted as far from each other as possible, and RF communication units corresponding to the cellular main antenna 10 and the cellular diversity antenna 20 can be located relatively close to the cellular main antenna 10 and the cellular diversity antenna 20, respectively, for performing cellular communication.

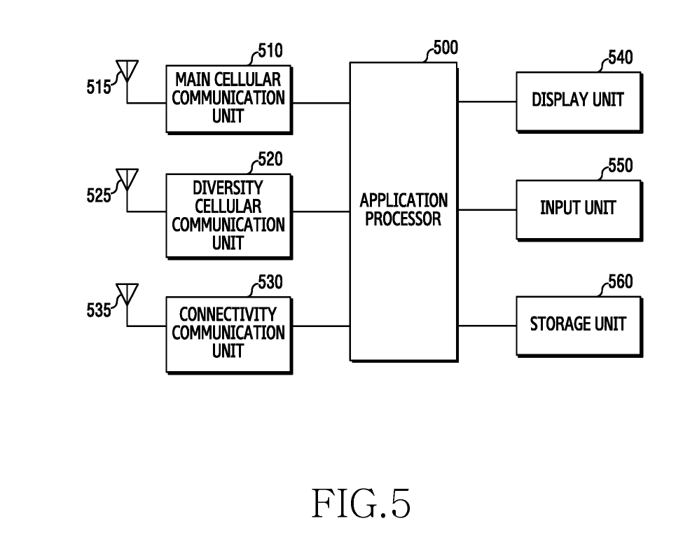

FIG. 5 is a diagram illustrating a UE apparatus, according to an embodiment of the present disclosure.

Referring to FIG. 5, the UE apparatus includes an Application Processor (AP; hereinafter, referred to as a controller) 500, a first (or main) cellular communication unit 510, a second (or diversity) cellular communication unit 520, a connectivity communication unit 530, a display unit 540, an input unit 550, and a storage unit 560.

Referring to FIG. 5, the first cellular communication unit 510 is connected to a first antenna 515 for transmitting/receiving signals. The second cellular communication unit 520 performs communication with a second antenna 525. Further, the first antenna 515 and the second antenna 525 can be mounted relatively far apart from each other within the UE apparatus. For example, the first antenna 515 can be mounted to an upper end of the UE apparatus, and the second antenna 525 can be mounted to a lower end of the UE apparatus. While, the first cellular communication unit 510 is shown as the main cellular communication unit, and the second cellular communication unit 520 is shown as the diversity cellular communication unit, the present disclosure is not so limited. For example, the first cellular communication unit 510 may be the diversity cellular communication unit, and the second cellular communication unit 520 may be the main cellular communication unit. Although two cellular antennas and a cellular communication unit are illustrated in FIG. 5, the UE apparatus may include three or more antennas and a cellular communication unit.

The connectivity communication unit 530 is connected to a connectivity antenna 535. Further, when a MIMO function is performed by the UE apparatus, two or more connectivity communication units 530 can be connected to corresponding connectivity antennas.

When the UE apparatus includes a plurality of cellular antennas and cellular transceivers and has a connectivity transceiver, a main cellular transceiver, which is connected to a main cellular antenna, can be integrated with a part or an entirety of the connectivity transceiver. For example, in the UE apparatus, of FIG. 5, which includes the first and second cellular communication units 510 and 520 connected to the first and second cellular antennas 515 and 525, respectively, the first cellular communication unit 510 which is connected to the first cellular antenna 510 can be integrated with a part or the entirety of the connectivity communication unit 530.

Further, when the UE apparatus includes a plurality of cellular antennas and cellular transceivers and has a connectivity transceiver, a diversity cellular transceiver connected to a diversity cellular antenna can be integrated with a part or an entirety of the connectivity transceiver. For example, the second cellular communication unit 520 which is connected to the second cellular antenna 525 can be integrated with a part or the entirety of the connectivity communication unit 530.

When the UE apparatus includes a plurality of cellular antennas and cellular transceivers and has a plurality of connectivity antennas and connectivity transceivers, a pair or a part of transmission and reception of MIMOs of the connectivity transceivers connected to the corresponding connectivity antennas can be integrated with a part or an entirety of the cellular transceivers. For example, when performing a MIMO function, two or more connectivity antennas can be connected to corresponding connectivity communication units 530.

Further, when a UE apparatus includes the first and second cellular communication unit 510 and 520 which are connected to the first and second cellular antennas 515 and 525, respectively, a pair or a part of transmission and reception of connectivity communication units connected to connectivity antennas corresponding thereto, can be integrated with a part or an entirety of the first cellular communication unit 510 and/or the second cellular communication unit 520.

Here, the communication units 510 and 520 may be provided with an RF communication unit and MODEMs or provided with only an RF communication unit. Thus, when a cellular communication unit and one or more connectivity communication units are configured as one integrated circuit, an RF communication unit, or an RF communication unit and a MODEM, may be integrated with the cellular communication unit and one or more connectivity communication units.

RF communication units of the cellular and connectivity communication units 510, 520, and 530 perform a function of transmitting/receiving a signal through a wireless channel, such as band conversion, amplification, etc. That is, the RF communication unit up-converts a baseband signal into an RF band signal, then transmits the up-converted RF band signal through an antenna and down-converts the RF band signal received through the antenna into a baseband signal. For example, the RF communication units may include a transmission filter, a reception filter, an amplification unit, a mixer, an oscillator, a Digital to Analog Convertor (DAC), an Analog to Digital Convertor (ADC), etc.

The cellular and connectivity communication units 510, 520, and 530 may or may not include a MODEM. When the communication units 510, 520, and 530 do not include a MODEM, the corresponding MODEM may be provided in the controller 500. The MODEM may include a modulator for modulating a signal in a set scheme, and a demodulator for demodulating the modulated signal. MODEMs of the cellular communication units 510 and 520 may be a MODEM which can process a signal in one scheme among communication schemes such as Wideband Code Division Multiple Access (WCDMA), Long-Term Evolution (LTE), and Time Division (TD)-CDMA. Further, a MODEM of the connectivity communication unit 530 may be a MODEM which can process information on connectivity communication such as Wi-Fi®, Bluetooth®, and GNSS.

The controller 500 controls overall operations of the UE apparatus. For example, the controller 500 can perform a communication function through the communication units 510, 520, and 530. Further, the controller 500 records and reads data according to the communication function in and from the storage unit 560.

The controller 500 receives a signal from the communication units 510, 520, and 530 and identifies a kind of the received signal. For example, the controller 500 identifies whether a signal received from the communication units 510, 520, and 530 is a signal received through the cellular main antenna 10, a signal received through the cellular diversity antenna 20, a signal received through the GNSS antenna 30, or a signal received through the Wi-Fi® or Bluetooth® antenna 40.

The controller 500 controls the identified reception signal according to a priority. For example, when a signal received through the Wi-Fi® antenna and a cellular signal (i.e., received through the main antenna 10) are identified, the controller 500 can control the UE apparatus using a signal having a high priority according to a predetermined priority.

Further, when performing communication in a diversity scheme, the controller 500 controls to perform communication through a signal having a higher intensity from among a signal received through the cellular main antenna 10 and a signal received through the cellular diversity antenna 20 or controls to perform communication by summing the two signals.

The storage unit 560 stores data such as a basic program for an operation of the UE apparatus, an application program, configuration information, etc. In particular, the storage unit 560 stores data received from various kinds of signals received from the communication units.

The display unit 540 displays a signal according to communication or application execution of the UE apparatus. The display unit 540 displays a state of the communication or the application execution and displays information (data and/or image) generated during execution under the control of the controller 500. The display unit 540 may be a Liquid Crystal Display (LCD) or an Organic Light Emitting Diode (OLED).

The input unit 550 detects an input of an electronic device. The input unit 550 may be a touch panel. The input unit 550 detects touches of a finger and a pen, or a hovering input of the same.

The display unit 540 and the input unit 550 can be configured by an integrated touch screen.

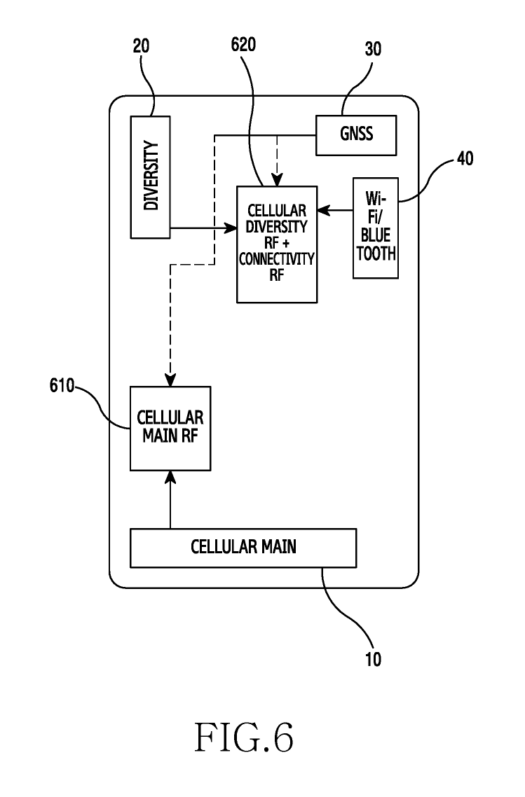

FIG. 6 is a diagram illustrating a cellular diversity chip and a connectivity chip that are configured as one chip, according to an embodiment of the present disclosure.

The cellular diversity antenna 20 is arranged relatively close to the other antennas, such as the GNSS antenna 30 or the Wi-Fi®/Bluetooth® antenna 40. When a cellular diversity chip and a connectivity chip are integrated into one chip, a distance between the cellular diversity antenna 20 and an RF chip 620 becomes shorter, so that loss of signal transfer is reduced.

In the UE apparatus of FIG. 6, a communication unit for the cellular main antenna 10 and a communication unit for a cellular diversity antenna 20 may exist in different chips. More particularly, the cellular main RF chip 610 communicates with the cellular main antenna 10 to transmit/receive signals. Further, the cellular diversity antenna 20 can communicate with the RF chip 620, in which the cellular diversity RF chip and the connectivity RF chip are integrated, to transmit/receive signals. The RF chip 620 can communicate with the GNSS antenna 30 and the Wi-Fi®/Bluetooth® antenna 40 as well as the cellular diversity antenna 20 to transmit/receive signals. Here, in order to improve efficiency, the cellular main antenna 10 and the cellular diversity antenna 20 can be arranged at opposite ends of the UE apparatus.

The cellular main antenna 10 and the cellular diversity antenna 20 are arranged at opposite ends of the UE, so that a distance therebetween is relatively large, and each antenna performs communication using a communication unit close to the corresponding antenna, so that deterioration of performance can be more reduced.

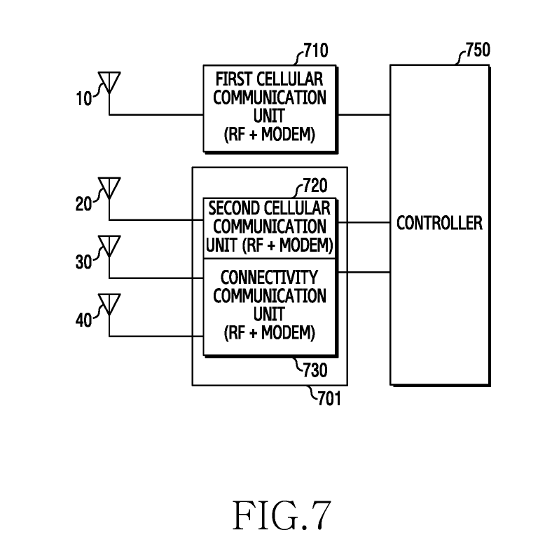

FIG. 7 is a diagram illustrating a UE apparatus having a cellular main antenna and a cellular diversity antenna performing communication through different chips, according to an embodiment of the present disclosure. Here, the first cellular communication unit 710 may be formed by integrating a main cellular RF chip and a cellular MODEM. A second cellular communication unit 720 may be formed by integrating a diversity cellular RF chip and a cellular MODEM. A connectivity communication unit 730 of FIG. 7 may be formed by integrating a connectivity RF chip and a connectivity MODEM. A communication unit 701 is one integrated circuit chip (chip 701) including the second cellular communication unit 720 and the connectivity communication unit 730.

The first cellular communication unit 710 can communicate with a controller 750, and the controller 750 can control the UE apparatus through received information.

Further, a cellular diversity RF chip communicating with the cellular diversity antenna 20 as well as a cellular main RF chip communicating with the cellular main antenna 10 may be provided on the second cellular communication unit 720, which is integrated with a MODEM.

An RF connectivity chip which performs connectivity communication as well as cellular communication may be provided on the connectivity communication unit 730, which is integrated with a MODEM. A connectivity RF chip that communicates with the GNSS antenna 30 or the Wi-Fi®/Bluetooth® antenna 40 may be provided on the connectivity communication unit 730, which is combined with a MODEM. Here, the second cellular communication unit 720 in which the cellular diversity RF chip and the MODEM are combined and the connectivity communication unit 730 in which the connectivity RF chip and the MODEM are combined may be integrated into the chip 701.

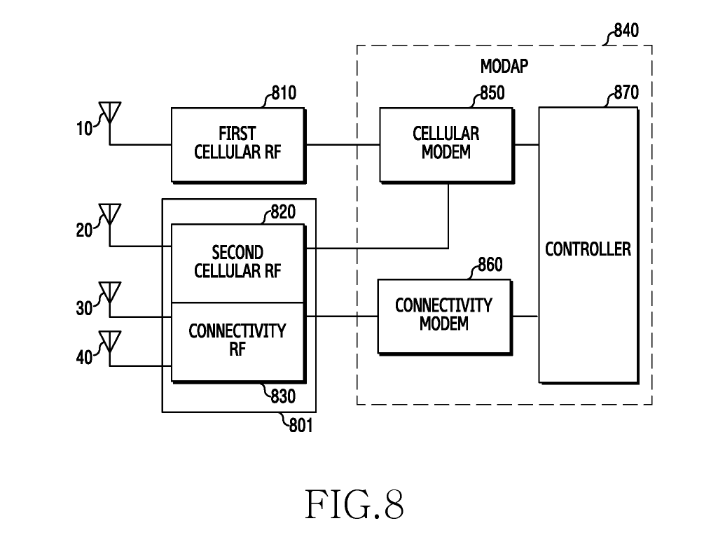

FIG. 8 is a diagram illustrating a UE apparatus having a cellular main antenna and a cellular diversity antenna performing communication through a chip in which a connectivity RF chip and a MODEM are integrated, according to an embodiment of the present disclosure. Here, a first cellular RF chip 810 may be a main cellular communication unit, and a second cellular RF chip 820 may be a diversity cellular communication unit. MODEMs 850 and 860 corresponding to the communication units, respectively, may be included in a controller 870. A communication unit 801 is configured as one integrated circuit chip (chip 801) including the second cellular RF chip 820 and a connectivity RF chip 830.

Referring to FIG. 8, the first cellular RF chip 810 can communicate with the cellular main antenna 10, and transmits/receives a signal to/from the cellular MODEM 850.

The second cellular RF chip communicating with the cellular diversity antenna 20 communicates with the cellular diversity antenna 20 and transmits/receives a signal to/from the cellular MODEM 850 while being configured separately from the MODEM 850.

The connectivity RF chip 830 which communicates with the GNSS antenna 30 or the Wi-Fi®/Bluetooth® antenna 40 may exist separately from the connectivity MODEM 860. The connectivity RF chip 830 can communicate with the GNSS antenna 30 or the Wi-Fi®/Bluetooth® antenna 40, and transmits/receives a signal to/from the connectivity MODEM 860.

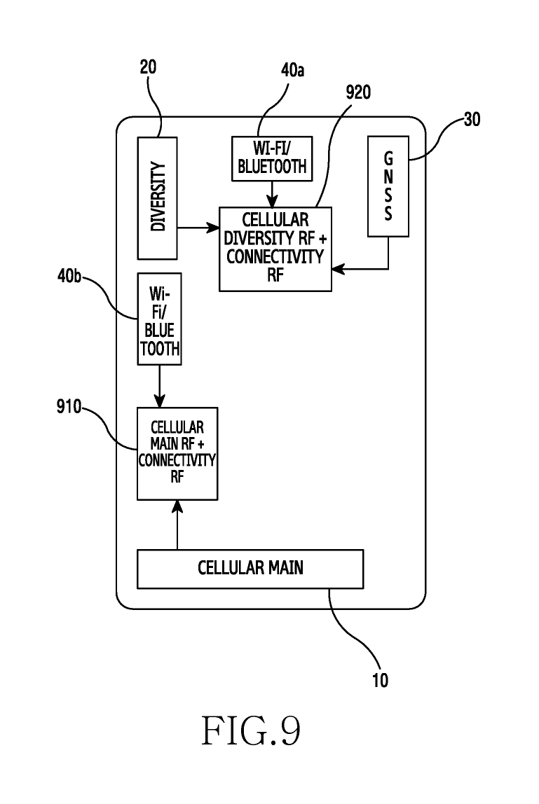

FIG. 9 is a diagram illustrating a cellular main RF chip and a diversity RF chip that are configured as one chip together with a connectivity RF chip, according to an embodiment of the present disclosure.

A MIMO transmission/reception scheme corresponds to a technology of maximally obtaining a transmission speed N times as compared with a Single Input Single Output (SISO) scheme without occupying an additional frequency spectrum. According to an embodiment of the present disclosure, two separate antennas can be installed in each UE according to a communication scheme.

FIG. 9 illustrates an example of an arrangement of antennas in a wireless UE to which MIMO Wi-Fi® is applied. Referring to FIG. 9, two MIMO Wi-Fi® antennas are spaced apart from each other by a suitable distance. The MIMO is not limited to Wi-Fi®, but can be also applied to Bluetooth® or ANT+. Although 2×2 MIMO is illustrated in FIG. 9, the MIMO may be extended to 3×3, 4×4, etc.

When a cellular diversity function and a connectivity function are integrated into one chip, a distance between the cellular diversity antenna 20 and an RF chip 920 is relatively short, so that loss of signal transfer is reduced.

In a UE apparatus of FIG. 9, a communication unit for the cellular main antenna 10 and a communication unit for a cellular diversity antenna 20 may exist in different chips. More particularly, the cellular main RF chip 910 communicates with the cellular main antenna 10. Additionally, the cellular main RF chip 910 communicates with Wi-Fi®/Bluetooth® antenna 40b. Since communication using a MIMO scheme requires a plurality of antennas, a plurality of Wi-Fi® antennas should be installed in the UE apparatus when communication is performed through a MIMO Wi-Fi scheme. Thus, in this case, when a first Wi-Fi® antenna is connected to a cellular diversity receiving unit, and a second Wi-Fi® antenna is connected to a cellular main receiving unit, the two Wi-Fi® antennas can be spaced apart from each other by a suitable distance. Further, each Wi-Fi® antenna communicates with a corresponding communication unit adjacent thereto, thereby reducing loss resulting from deterioration.

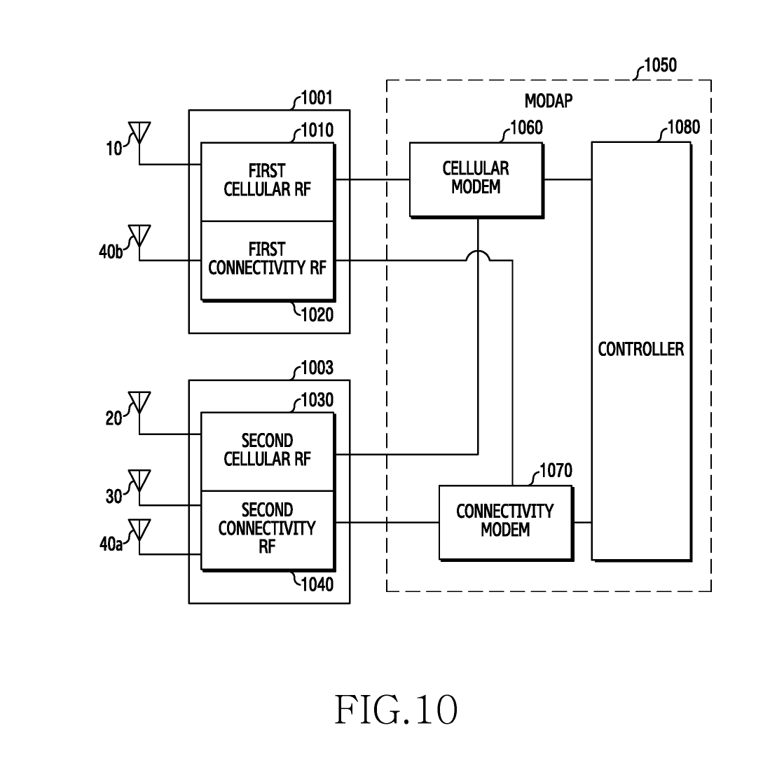

FIG. 10 is a diagram illustrating a UE apparatus having a cellular main antenna and a cellular diversity antenna performing communication through an RF chip in a MIMO scheme, according to an embodiment of the present disclosure.

Referring to FIG. 10, a first cellular RF chip 1010 communicates with the cellular main antenna 10, and transmits/receives a signal to/from a cellular MODEM 1060 within a MODAP 1050.

A second cellular RF chip 1030 communicating with the cellular diversity antenna 20 communicates with the cellular diversity antenna 20 and transmits/receives a signal to/from the cellular MODEM 1060 within the MODAP 1050 while being configured separately from the cellular MODEM 1060 within the MODAP 1050.

A connectivity RF chip 1020 and a second connectivity RF chip 1040 which communicate with the GNSS antenna 30 or the Wi-Fi®/Bluetooth® antenna 40 may exist separately from a connectivity MODEM 1070. The first connectivity RF chip 1020 and the second connectivity RF chip 1040 communicate with the GNSS antenna 30 or the Wi-Fi®/Bluetooth® antenna 40, and transmit/receive a signal to/from the connectivity MODEM 1070.

A controller 1080 included in the MODAP 1050 receives a signal from the cellular MODEM 1060 or the connectivity MODEM 1070 to control the UE apparatus. Further, the controller 1080 transmits information of the UE using the cellular MODEM 1060 or the connectivity MODEM 1070.

The cellular diversity RF chip 1010 and the connectivity RF chip 1020 may be integrated into one chip 1001. Further, the cellular diversity RF chip 1030 and the connectivity RF chip 1040 may be integrated into one chip 1003.

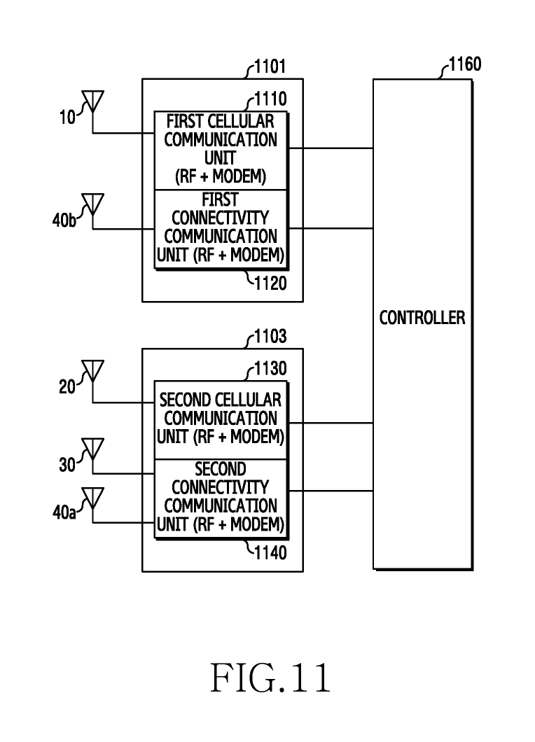

FIG. 11 is a diagram illustrating a UE apparatus having a cellular main antenna and a cellular diversity antenna performing communication through a chip, in which an RF chip and a MODEM are integrated, in a MIMO scheme, according to an embodiment of the present disclosure.

Referring to FIG. 11, a first cellular communication unit 1110 may exist in a form in which a cellular RF chip and a cellular MODEM are integrated into one chip, and can perform communication through the cellular main antenna 10. The first cellular communication unit 1110 can transmit a signal received through the cellular main antenna 10 to a controller 1160, or transmit information controlled through the controller 1160 to the cellular main antenna 10.

A first connectivity communication unit 1120 may exist in a form in which a connectivity RF chip and a connectivity MODEM are integrated into one chip, and can perform connectivity communication as well as the cellular communication. The first connectivity communication unit 1120 can perform communication through a connectivity antenna 40b, and transmit a signal received through the connectivity antenna 40b, to the controller 1160, or transmit information controlled through the controller 1160, through the connectivity antenna 40b. Here, the connectivity antenna 40b may be an antenna for Wi-Fi®/Bluetooth®, and the connectivity antenna 40b for Wi-Fi®/Bluetooth® communication may perform communication in a MIMO scheme together with another connectivity antenna 40a.

Here, the first cellular communication unit 1110 and the first connectivity communication unit 1120 may be integrated into one chip 1101.

Further, a second cellular communication unit 1130 in which a cellular RF chip and a cellular MODEM are integrated into one chip can perform communication through the cellular diversity antenna 20, and transmit a signal received through the cellular diversity antenna 20 to the controller 1160 or transmit information controlled through the controller 1160, through the cellular diversity antenna 20.

The second connectivity communication unit 1140 in which the connectivity RF chip and the connectivity MODEM are integrated into one chip can perform communication through a connectivity antenna 40a, and transmit a signal received through the connectivity antenna 40a, to the controller 1160, or transmit information controlled through the controller 1160, through the connectivity antenna 40a. Here, the connectivity antenna 40a may be an antenna for Wi-Fi®/Bluetooth®, and the connectivity antenna 40a for Wi-Fi®/Bluetooth® may perform communication in a MIMO scheme together with another connectivity antenna 40b.

Here, the second cellular communication unit 1130 and the second connectivity communication unit 1140 may be integrated into one chip 1103.

Methods and apparatuses disclosed herein may be implemented in the form of hardware, software, or a combination thereof

In the implementation of software, a non-transitory computer-readable storage medium for storing one or more programs (software modules) may be provided. The one or more programs stored in the non-transitory computer-readable storage medium may be configured for execution by one or more processors within the electronic device, e.g., one or more of the UE apparatuses disclosed above. The at least one program may include instructions that cause the electronic device to execute the methods according to embodiments disclosed herein.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Otherwise, the programs can be stored in a memory configured by a combination of some or all of them. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access an electronic device performing the embodiments of the present disclosure.

In the above-described detailed embodiments of the present disclosure, a component included in the present disclosure is expressed in the singular or the plural according to a presented detailed embodiment. However, the expression of the singular or the plural is selected to be suitable for a presented situation for the convenience of the description, and the present disclosure is not limited to the singular or plural components. Thus, components expressed in the plural may be configured to be the singular, or a component expressed in the singular may be configured to be the plural.

While the present disclosure has been shown and described with reference to certain embodiments thereof, it should be understood by those skilled in the art that many variations and modifications of the method and apparatus described herein will still fall within the spirit and scope of the present disclosure as defined in the appended claims and their equivalents.

What is claimed is:

1. A User Equipment (UE) apparatus in a communication system, the UE apparatus comprising:
a first cellular antenna;
a second cellular antenna mounted on the UE apparatus at a location spaced apart from the first cellular antenna;
a connectivity antenna mounted on the UE apparatus at a location adjacent to the second cellular antenna;
a first cellular communication unit connected to the first cellular antenna; and
an integrated circuit including a second cellular communication unit that is connected to the second cellular antenna and a connectivity communication unit that is connected to the connectivity antenna.

2. The UE apparatus of claim 1, wherein the first cellular antenna and the second cellular antenna are mounted at opposite ends of the UE apparatus.

3. The UE apparatus of claim 1, wherein the first cellular antenna is a cellular main antenna and the second cellular antenna is a cellular diversity antenna.

4. The UE apparatus of claim 1, wherein the connectivity communication unit comprises at least one of a Wireless-Fidelity (Wi-Fi®) communication unit, a Global Navigation Satellite System (GNSS) communication unit, and a Bluetooth® communication unit.

5. The UE apparatus of claim 1, wherein the first cellular antenna has a size that is greater than a size of the second cellular antenna.

6. The UE apparatus of claim 1, wherein the first cellular antenna has a distance between the second cellular antenna and the first cellular antenna is greater than a distance between the second cellular antenna and the connectivity antenna.

7. The UE apparatus of claim 1, wherein the first cellular communication unit, the second cellular communication unit and the connectivity unit include Radio Frequency (RF) communication unit and a base band modem.

8. The UE apparatus of claim 4, further comprising:
a second connectivity antenna mounted on the UE apparatus at a location adjacent to the first cellular antenna; and
a second connectivity communication unit comprising a Wi-Fi® communication unit connected to the second connectivity antenna,
wherein the second connectivity communication unit is formed on an integrated circuit with the first cellular communication unit, and performs Multi-Input Multi-Output (MIMO) communication of a Wi-Fi® signal.

9. The UE apparatus of claim 4, further comprising:
a second connectivity antenna mounted on the UE apparatus at a location adjacent to the first cellular antenna; and
a second connectivity communication unit comprising a Wi-Fi® communication unit and a Bluetooth® communication unit each connected to the second connectivity antenna,
wherein the second connectivity communication unit is formed on an integrated circuit with the first cellular communication unit, and performs MIMO communication of a Wi-Fi® signal and a Bluetooth® signal.

10. A method of a User Equipment (UE) apparatus which includes a first cellular antenna, a second cellular antenna mounted at a location spaced apart from the first cellular antenna, a connectivity antenna mounted at a location adjacent to the second cellular antenna, a first cellular communication unit connected to the first cellular antenna, a second cellular communication unit connected to the second cellular antenna and a connectivity communication unit connected to the connectivity antenna, the method comprising:
performing cellular communication through the first cellular antenna and the second cellular antenna by the first cellular communication unit and the second cellular communication unit in a cellular communication mode, respectively; and
performing connectivity communication through the connectivity antenna by the connectivity communication unit in a connectivity communication mode.

11. The method of claim 10, wherein the first cellular antenna and the second cellular antenna are mounted at opposite ends of the UE apparatus.

12. The method of claim 10, wherein, in the cellular communication mode, main communication is performed through the first cellular communication unit and diversity communication is performed through the second cellular communication unit.

13. The method of claim 10, wherein, in the connectivity communication mode, communication is performed by at least one of a Wireless-Fidelity (Wi-Fi®) communication unit, a GNSS communication unit, and a Bluetooth® communication unit.

14. The method of claim 10, wherein the first cellular antenna has a size that is greater than a size of the second cellular antenna.

15. The method of claim 10, wherein the first cellular antenna has a distance between the second cellular antenna and the first cellular antenna is greater than a distance between the second cellular antenna and the connectivity antenna.

16. The method of claim 10, wherein the first cellular communication unit, the second cellular communication unit and the connectivity unit include Radio Frequency (RF) communication unit and a base band modem.

17. The method of claim 13, wherein the UE apparatus further comprises: a second connectivity antenna mounted at a location adjacent to the first cellular antenna; and a second connectivity communication unit including a Wireless-Fidelity (Wi-Fi®) communication unit connected to the second connectivity antenna, the second connectivity communication unit configured to perform Multi-Input Multi-Output (MIMO) communication of a Wi-Fi® signal.

18. The method of claim 13, wherein the UE apparatus further comprises: a second connectivity antenna mounted at a location adjacent to the first cellular antenna; and a second connectivity communication unit including a Wi-Fi® communication unit and a Bluetooth® communication unit, each of which connected to the second connectivity antenna, the second connectivity communication unit is integrated into one chip together with the first cellular communication unit, and performs MIMO communication of a Wi-Fi® signal and a Bluetooth® signal.

19. A chipset for use with a User Equipment (UE) apparatus which includes a first cellular antenna, a second cellular antenna mounted at a location spaced apart from the first cellular antenna, a connectivity antenna mounted at a location adjacent to the second cellular antenna, a first cellular communication unit connected to the first cellular antenna, a second cellular communication unit connected to the second cellular antenna and a connectivity communication unit connected to the connectivity antenna , configured to:
perform cellular communication through the first cellular antenna and the second cellular antenna by the first cellular communication unit and the second cellular communication unit in a cellular communication mode, respectively; and
perform connectivity communication through the connectivity antenna by the connectivity communication unit in a connectivity communication mode.

20. The chipset of claim 19, wherein the first cellular antenna and the second cellular antenna are mounted at opposite ends of the UE apparatus, and
wherein in the cellular communication mode, main communication is performed through the first cellular communication unit and diversity communication is performed through the second cellular communication unit.
